(19) United States
(12) Patent Application Publication
(10) Pub. No.: US 2026/0109305 A1
(43) Pub. Date: Apr. 23, 2026

(54) DIGITAL VIRTUAL FUSE

(71) Applicant: International Truck Intellectual Property Company, LLC, Lisle, IL (US)

(72) Inventors: Brian Jacobs, Chesterfield, MI (US); Irving Hernandez, Oxford, MI (US)

(73) Assignee: International Truck Intellectual Property Company, LLC, Lisle, IL (US)

(21) Appl. No.: 18/918,749

(22) Filed: Oct. 17, 2024

(51) Int. Cl. B60R 16/023; B60R 16/03

(52) U.S. Cl. CPC B60R 16/0232; B60R 16/03; B60L 2240/42; B60L 2250/16

(57) ABSTRACT

The present disclosure generally relates to the electrical system of a vehicle. Specifically, the present disclosure relates to an improved, customizable digital virtual fuse integrated into a software application useful for programming and configuring electrical systems on high performance vehicles, including electric and hybrid electric vehicles.

### TECHNICAL FIELD

The present disclosure relates generally to the electrical system of a vehicle. Specifically, the present disclosure relates to an improved, customizable digital virtual fuse integrated into a software application useful for programming and configuring electrical systems on high performance vehicles.

### BACKGROUND

Electrical systems in modern vehicles, including electric vehicles and hybrid electric vehicles require high performance programming, diagnostics and configurations. Body and cab diagnostic and programming software is useful for monitoring the multiplexed electrical system of a vehicle. The software application provides diagnostics for the electrical system and can read and display a vehicle's diagnostic trouble codes as well as the vehicle's characteristics and perimeters. An example of this type of software is the Navistar Diamond Logic® Builder (DLB) software application, which is designed to easily integrate chassis and body electrical systems and accommodate an infinite variety of vehicle configuration options. This software application provides the ability to diagnose and simulate features in the Electrical System Controller or Body Controller (ESC/BC) module on vehicles. The ESC/BC receives inputs from driver controls, sensors and switches providing outputs to vehicle loads, gauges, relays and remotely mounted modules. Software to control a vehicle's specific electrical/electronic features and components is programmed into the ESC/BC using a computer.

Electric Vehicle (EV) and Hybrid Electric Vehicle (HEV) applications utilize electrical power take off (ePTO), a technology that powers auxiliary functions on vehicles electrically, replacing traditional combustion engine methods. An ePTO system utilizes electrical power from a battery or electric motor and transmits this power to auxiliary functions or equipment on vehicles.

Fuses used in EV and HEV applications protect electrical circuits, electrical equipment and batteries in an electric vehicle from electrical faults such as overloads and short circuits. In EV applications where an Electrical Power take off (ePTO) is used, there is a need to size a fuse accordingly with the power needs of the load and the size of the cable that feeds electrical current. Traditional methods require that the design of parts, such as the fuse carrier box inside of the ePTO device, accommodate different size fuses as may be required for the different power needs of various loads. For example, powering a load requiring a higher power may require replacement of a fuse for a different fuse having a higher rated current; however these prior requirements affect the size of the fuse carrier box, increase the complexity of the overall design and may create maintenance and repair delays to the customer.

Therefore, there is a need for an improved electrical system incorporating a digital virtual fuse for use in electric vehicle applications, wherein the digital virtual fuse is integrated into an existing body and cab diagnostic and programming software application.

A need further exists for an improved digital virtual fuse incorporated into the ePTO module integrated into an existing body and cab diagnostic and programming software application for use in electric vehicle applications.

A need also exists for an improved digital virtual fuse for use in the ePTO module for electric vehicle applications wherein the fuse voltage rating can be customized by the customer in real time depending on the power needs of a load by utilizing the body and cab diagnostic and programming software application.

A need further exists for an improved digital virtual fuse having a defined current voltage range so that the electrical performance of the ePTO can be modified without modifications to the hardware or requiring additional parts.

### SUMMARY

The present disclosure relates to an improved electrical system of a vehicle, including high performance electric and hybrid electric vehicles. Specifically, the present disclosure relates to an electrical system controller incorporating an improved digital virtual fuse integrated into an interface of a body and cab diagnostic and programming software application useful for monitoring the multiplexed electrical system of a vehicle. Through integration with the existing software application, the voltage rating of the digital virtual fuse is customizable, including in real time, providing numerous advantages including avoiding modifications and/or replacement to associated hardware.

To this end, in an embodiment of the present disclosure, an improved electrical system control for an electric/hybrid vehicle incorporating a virtual fuse is provided.

In an embodiment of the present disclosure, an electrical system of an electric/hybrid vehicle is provided comprising an electrical system controller, a series of modules incorporated within the electrical system controller, wherein the modules are configured to operate various electronic components of the electric vehicle, and, a virtual fuse integrated into one of the series of modules.

It is, therefore, an advantage and objective of the present disclosure to provide an improved, customizable digital virtual fuse integrated into a software application useful for programming and configuring electrical systems on high performance vehicles.

It is a further advantage and objective of the present disclosure to provide a digital virtual fuse within the ePTO module integrated into an existing body and cab diagnostic and programming software for electric vehicle applications.

It is a further advantage and objective of the present disclosure to provide a digital virtual fuse, wherein the fuse voltage rating can be customized by the customer.

It is a further advantage and objective of the present disclosure to provide an improved digital virtual fuse having a defined a current voltage range so electrical performance of the electric power takeoff (ePTO) for a vehicle can be modified without modifications to the hardware or requiring changing or adding parts.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a schematic diagram of an example of an electrical system controller incorporating a digital virtual fuse integrated into a software application useful for programming, configuring and diagnostics of electrical systems on high performance vehicles.

### DETAILED DESCRIPTION

The present disclosure relates generally to the electrical system of a vehicle. Specifically, the present disclosure relates to an improved, customizable digital virtual fuse integrated into a software application useful for programming and configuring electrical systems on high performance vehicles, including electric and hybrid electric vehicles.

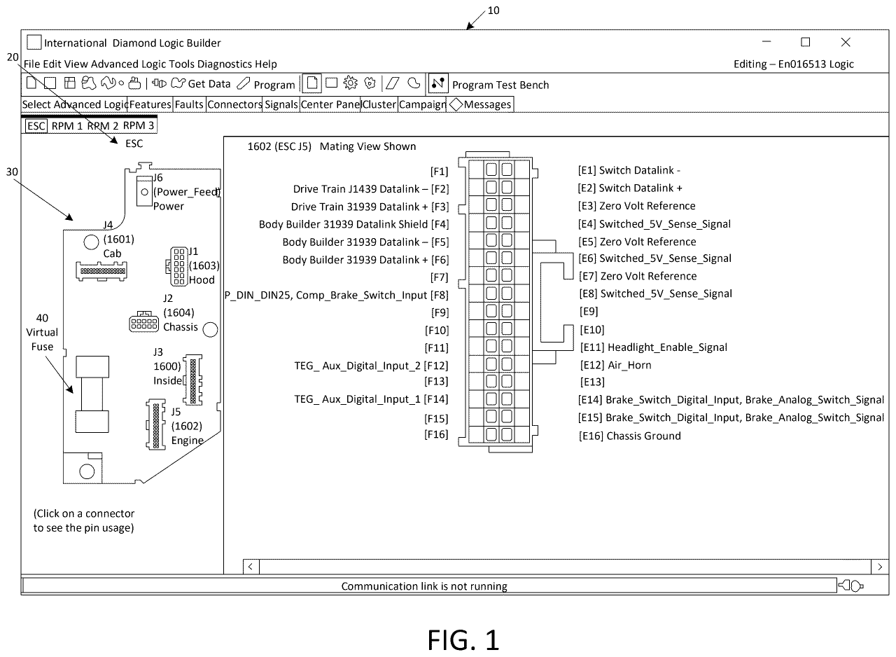

Now referring to the figures, wherein like numerals refer to like parts, FIG. 1 illustrates an example of a schematic diagram for a software application useful for programming, configuring and diagnostics of electrical systems on high performance vehicles, including electric and hybrid electric vehicles. Today's electric and hybrid electric vehicles utilize electric power takeoff (ePTO) technology that powers auxiliary functions on vehicles electrically, replacing traditional combustion engine methods. Traditionally, a fuse carrier inside of the ePTO module would be needed to accommodate different size fuses for different power loads. FIG. 1 illustrates the creation of a digital virtual fuse within the ePTO module inside of the software application to overcome the complexity of prior designs.

The software application 10 of the present disclosure provides the functionality of a graphic interface to program new software features into a vehicle, while also providing for evaluation of behavior of new functions virtually and remotely. Integrated within the software application 10 is an electrical system controller (ESC) 20. The ESC 20 is the main processor or “heart” of the multiplexed electronic system. The ESC receives inputs from driver controls, sensors and switches providing outputs to vehicle loads, gauges, relays and remotely mounted modules. For example, the ESC 20 may incorporate various modules including hood 31, chassis 32, inside 33, cab 34, and engine 35 (FIG. 1). Software to control a vehicle's specific electrical/electronic features and components is programmed into the ESC using a computer.

Incorporated within the ePTO module 30 of the ESC 20, is a digital virtual fuse 40. In the present disclosure, the value of the digital virtual fuse 40 is adjusted or customized utilizing the software application 10 to limit the actual current output of the ePTO based on the specified limit. An advantage of the present digital virtual fuse 40 is that the fuse voltage rating of the virtual fuse 40 can be customized by the customer, including in real time, depending on the power needs of a load. This customization is accomplished through use of the existing software application 10. In this manner, electrical performance of the ePTO can be modified without modifications, changes or additions to the hardware or additional part requirements.

Traditional methods require that to power a load that consumes higher power, existing fuse or fuses may need to be replaced for a higher rated fuse. This requirement creates cost and downtime issues for the customer, and complexity for managing and storing multiple parts. Incorporating the virtual fuse 40 of the present disclosure into the existing software application 10 means the virtual fuse can be programmed to meet the power requirements of various loads, saving time, money and complexity for the customer. Software functionality could be added to acquire data over time to build a database of information to be used to statistically optimize ratings of real fuses in future designs.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

We claim:

1. An electrical power takeoff system of an electric vehicle comprising:
an electrical system controller;
a series of modules incorporated within the electrical system controller, wherein the modules are configured to operate various electronic components of the electric vehicle; and,
a virtual fuse integrated into at least one of the series of modules.

2. The electrical system of claim 1, wherein the electrical system controller includes a software application having a graphical interface configured for programming software features into a vehicle.

3. The electrical system of claim 1, wherein the electrical system controller includes an electrical power takeoff module.

4. The electrical system of claim 3, wherein the electrical power takeoff module incorporates a plurality of fuses.

5. The electrical system of claim 4, wherein at least one of the fuses is a digital virtual fuse.

6. The electrical system of claim 5, wherein a rating of the digital virtual fuse is configured based on power needs of the vehicle.

7. The electrical system of claim 6, wherein the rating of the digital fuse is configured for limiting a current output of the electrical power takeoff module based on the power needs of the vehicle.

8. The electrical system of claim 7, wherein the rating of the digital fuse is configured in real time.

9. An electrical system for a vehicle, the system comprising:
an electrical system controller;
a series of modules within the electrical system controller;
at least one digital virtual fuse incorporated within the series of modules; wherein the digital fuse is configured for programming by a software application; and,
wherein the vehicle is an electric vehicle or a hybrid electric vehicle.

10. The electrical system of claim 9, wherein one of the modules is an electrical power takeoff module incorporating the digital virtual fuse.

11. The electrical system of claim 10, wherein a rating of the digital virtual fuse is configured for limiting a current output of the electrical power takeoff module based on the power needs of the vehicle.
